(19) United States
(12) Patent Application Publication
(10) Pub. No.: US 2008/0212418 A1
(43) Pub. Date: Sep. 4, 2008

(54) OPTICAL DISC DEVICE

(75) Inventors: Kazuhiro Nagata, Yokohama-shi (JP); Katsuo Iwata, Yokohama-shi (JP); Hideaki Okano, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/022,953

(22) Filed: Jan. 30, 2008

(30) Foreign Application Priority Data
Jan. 31, 2007 (JP) 2007-022251

(51) Int. Cl. G11B 7/00

(52) U.S. Cl. 369/44.32; 369/112.23

(57) ABSTRACT

According to one embodiment, an optical head device provides a signal processing circuit which sets a control amount to move an objective lens so that a distance between the objective lens and a given recording layer of the an optical disc coincides with a focal position, an optical path length correction mechanism which corrects an influence of an aberration component producing an error in the focal distance, a thickness difference detection circuit which finds an amount of correction to be made by the optical path length, and an aberration correction circuit which generates a correction signal to correct the influence of the aberration component producing the error in the focal distance detected by the thickness difference detection circuit, and supplies the correction signal to the optical path length correction mechanism.

### CROSS-REFERENCE TO RELATED APPLICATIONS

This application is based upon and claims the benefit of priority from Japanese Patent Application No. 2007-022251, filed Jan. 31, 2007, the entire contents of which are incorporated herein by reference.

### BACKGROUND

1. Field

One embodiment of the invention relates to an optical disc device capable of reducing the influence of spherical aberration caused by the difference of the thickness of an optical disc in which a recording layer is provided using a transparent resin material as a substrate or by the difference of the thickness of an intermediate layer in an optical disc provided with two or more recording layers. This invention also relates to an optical head device incorporated in the optical disc device.

2. Description of the Related Art

It has been a long time since information recording media capable of recording and reproducing information using laser light, that is to say, optical discs were put to practical use. On the other hand, in regard to standards of the optical discs, a digital versatile disc (DVD) standard has appeared following a compact disc (CD) standard, and an HD DVD standard which has further increased the density of the DVD standard is already in practical use.

In the optical discs of the DVD standard and the HD DVD standard, there is another optical disc called a double layer or DL having two or more recording layers to increase recording capacity.

In such an optical disc having two or more recording layers, third-order spherical aberration (SA3) is caused by the difference of the thickness of a disc substrate such as a polycarbonate layer extending up to a desired recording layer.

It is known that this SA3 deteriorates reproduction/recording characteristics.

Although there are techniques for mechanically controlling a lens or using a liquid crystal element to correct the SA3, a detection signal for control is required in order to control the lens for each disc or for each radial position of the disc.

For example, Japanese Patent Application Publication (KOKAI) No. 2003-91851 has disclosed detecting a zero crossing of a focus error signal in one point (0.6 mm) of the thickness of a referential substrate, and determining the distance between the surface of the optical disc and a recording layer (zero crossing point) as the thickness of the substrate.

However, the Publication shows the detection of the substrate thickness using the zero crossing of the focus error signal, it does not explain that the result of detecting the distance between the surface of the substrate and the recording layer using the zero crossing is used to eliminate spherical aberration components.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an optical disc device according to an embodiment of the invention;

FIGS. 2A and 2B are exemplary diagrams showing an example of a principle of detecting the difference of the thickness of a transparent substrate of the optical disc shown in FIG. 1 or the difference of the thickness of an intermediate layer, according to the embodiment of the invention; and

FIG. 3 is an exemplary diagram showing an example of an optical disc device according to another embodiment of the invention.

### DETAILED DESCRIPTION

Various embodiments according to the invention will be described hereinafter with reference to the accompanying drawings. In general, according to one embodiment of the invention, an optical disc device comprising: moving an actuator holding a lens which converges light from a light source on a recording layer of a recording medium to a predetermined position distant from the recording layer of the recording medium, and then locating the actuator in a direction to gradually approach the recording layer of the recording medium; finding, from a movement amount which inverts the polarity of an output of a photodetector, a first output obtained a predetermined amount before the movement amount which inverts the polarity of the output of the photodetector output by the movement of the lens, and a second output obtained a predetermined amount after the movement amount which inverts the polarity of the output of the photodetector, with regard to each of the surface of a transparent substrate of the recording medium and the recording layer thereof; finding the thickness of the transparent substrate at a plurality of radial positions in a recording surface of the recording medium and at a plurality of positions on the same radius, from the surface of the transparent substrate and the recording layer which have been found; and correcting a focal distance inherent in the lens by use of the thickness of the transparent substrate found at the plurality of radial positions in the recording surface of the recording medium and at the plurality of positions on the same radius.

Embodiments of this invention will be described in detail with reference to the drawings.

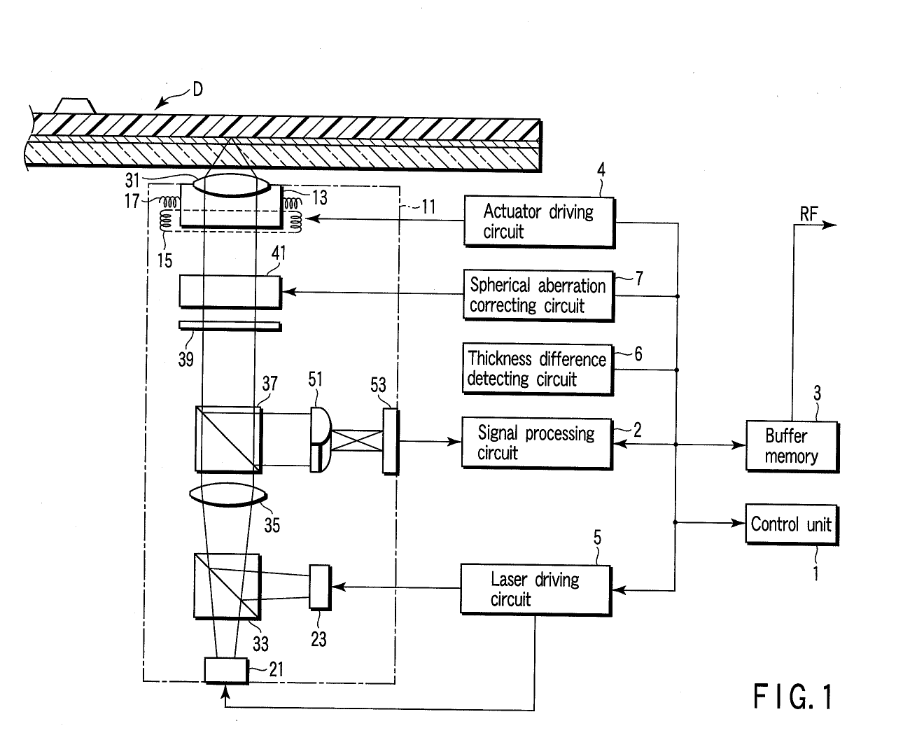

FIG. 1 is a schematic diagram explaining one example of an optical disc device to which the embodiment of this invention is applied.

An optical disc device 101 shown in FIG. 1 includes an optical head device (pickup head [PUH]) 11 capable of recording information in two or more recording layers formed in an optical disc (recording medium) D or reading information recorded in a given recording layer or erasing information recorded in a given recording layer.

Although not described in detail, the optical disc device 101 includes, in addition to the PUH 11, mechanical elements such as an unshown head moving mechanism for radially moving the PUH 11 along a recording surface of the optical disc D and an unshown disc motor for rotating the optical disc D at a predetermined velocity, a signal processing system described later, etc.

While an optical disc having two or more recording layers is described as an example in the embodiments of this invention, it goes without saying that, in an optical disc having a single recording layer as well, the thickness of a transparent resin layer, that is to say, a substrate can be detected by a similar configuration and detection principle and the difference of the detected thickness can be used to correct the influence of spherical aberration.

A recording film made of, for example, an organic film or metal film or phase-change film is used for a given recording layer of the optical disc D, and a guide groove, that is to say, a track or recording mark (recorded data) row is concentrically or spirally formed, for example, at a pitch of 0.34 to 1.6 μm in each recording layer.

For example, two recording layers are provided in the optical disc D, the first layer, interposed between, for example, dielectric protection films, is located at 0.6 mm including the thickness of the transparent substrate, and the second layer, interposed between dielectric protection films, is located at 0.62 mm with an intermediate layer in between.

The PUH 11 includes a lens holder 13 which supports an objective lens described later movably in a direction perpendicular to the recording surface of the optical disc D, that is, a focus direction and in a direction along the radial direction of the optical disc D, that is, a tracking direction, a focus coil 15 which moves the lens holder 13 in the focus direction, and a tracking coil 17 which generates thrust for moving the lens holder 13 in the track direction. In addition, the lens holder 13, when holding the objective lens and incorporating the focus coil 15 and the tracking coil 17, is referred to as, for example, an actuator.

The PUH 11 also includes, at predetermined positions, first and second light sources (hereinafter indicated as LDs) 21, 23 which are, for example, semiconductor laser elements, that is to say, laser diodes, and an objective lens 31 which gives a predetermined focusing property to light beams output from the LDs 21, 23. The objective lens 31 is made of, for example, plastic, and has a numerical aperture NA of, for example, 0.65. As described above, the objective lens 31 is supported by the lens holder 13 movably in the focus direction and the tracking direction.

Although not described in detail, the first LD 21 is preferably arranged so that the chief ray (on-axis light) of the output light beam is directed perpendicularly to the recording surface of the optical disc D when unshown mirrors, etc. for changing the optical path of the light beam are excluded.

The second LD 23 is superposed on an optical path between the first LD 21 and the optical disc D via a first splitter (mirror prism) 33 inserted at a predetermined position in the optical path directed from the first LD 21 to the optical disc D. In addition, the light beams are not simultaneously output from the first LD 21 and the second LD 23.

It is to be noted that the first splitter 33 is preferably a polarizing beam splitter (PBS), that is to say, polarizing splitting element. Although not shown, the direction of the polarization of a polarization plane (mirror surface) is arranged to transmit most of the light beam output by the first LD 21 and to reflect most of the light beam output by the second LD 23.

The wavelength of the light beam output from the first LD 21 is, for example, 400 to 410 nm, and preferably 405 nm. The first LD 21 is used to record information on and reproduce information from an optical disc of a standard called an HD DVD in which the pitch of a track or recording mark row provided in a recording layer thereof is set to about 0.4 μm.

The second LD 23 outputs a light beam at a wavelength of, for example, 650 to 660 nm, and preferably 655 nm. The light beam of a wavelength of 655 nm from the second LD 23 is used to record information on and reproduce information from an optical disc of a standard called a DVD in which the pitch of a track or recording mark row T is set to about 0.74 μm.

Arranged between the first splitter (PBS) 33 and the objective lens 31 are, from the side of the first splitter 33 in order, a collimator (lens) 35 which converts the light beam transmitted in the first splitter 33 (directed to the optical disc D) into parallel light, a second splitter (mirror prism, splitting element) 37 which separates the light beam directed to the optical disc D from a reflection light beam reflected by the recording layer of the optical disc D, a λ/4 plate 39 which matches the isolation of the light beam directed from each LD to the optical disc with the isolation of the reflection light beam reflected by the optical disc, a refractive index converting element (ECB, electrically controlled birefringence type liquid crystal element) 41 which gives a predetermined focusing property to the light beam directed to the optical disc D, etc.

Although not shown, a diffracting element (or a wavefront dividing element) such as a hologram optical element (HOE) is provided at a position between the objective lens 31 and the PBS 33 to give a predetermined wavefront property to the light beam directed to the optical disc D and the reflection light beam reflected by the recording layer of the optical disc when necessary in accordance with the shape and arrangement of a light receiving region of a photodetector described later.

The refractive index converting element 41 changes its birefringent component in response to a voltage applied across electrodes interposed between a liquid crystal layer, and, as described layer, its refractive index is changed by a voltage output from a spherical aberration correction circuit.

The refractive index converting element 41 can suppress the degree of variation in the spot diameter of the light beam focused by the objective lens 31 due to the difference of the thickness of the transparent substrate or due to the difference of the thickness of the intermediate layer disposed between the respective recording layers when information is reproduced from a given recording layer of the optical disc D or when information is recorded in a given recording layer of the optical disc D.

In addition, in the optical disc D provided with two or more recording layers, more influence of spherical aberration is produced due to the accumulation of thickness differences in the recording layers farther from the surface of the transparent substrate, that is to say, in the second recording layer, third recording layer and so on, as the number of recording layers increases.

In a direction in which the reflection light beam separated from the light beam directed to the optical disc D is guided by the second splitter 37, there are arranged, from the side of the second splitter 37 in order, an imaging optical system 51 which gives a predetermined imaging property to the reflection light beam, a photodetector (PD) 53 which receives the reflection light beam given the predetermined imaging property by the imaging optical system 51 and outputs an output signal corresponding to the intensity of the received reflection light beam, etc.

In the PUH 11 described above, an output signal in a predetermined format is generated by a signal processing unit 2 which processes the output of the PD 53 incorporated in the PUH 11.

For example, the output from the signal processing unit 2 is first supplied to a buffer memory 3 for temporarily retaining the output of the signal processing unit 2 to obtain reproduction information, and temporarily retained therein.

The output from the signal processing unit 2 is also supplied to an actuator driving circuit 4 which generates a control signal for controlling the position of the objective lens 31, that is to say, the lens holder 13, and used as a focus control signal or tracking control signal for changing the position of the objective lens 31 held by the lens holder 13.

The signal processing unit 2, the buffer memory 3 and the actuator driving circuit 4 that have been described above are connected to a control unit 1 and operated under the control of the control unit 1.

Also connected to the control unit 1 are a laser driving circuit 5 which controls the outputs of the first and second LDs 21, 23, a thickness difference detection circuit 6 which finds, from the output signal supplied from the signal processing unit 2 to the actuator driving circuit 4.

For example, the thickness of the transparent substrate of the optical disc D, that is to say, the distance from the surface of the transparent substrate to the first recording layer or the thickness of the intermediate layer.

The distance between the first recording layer and the second recording layer, a spherical aberration correction circuit 7 which controls the voltage to be applied to the refractive index converting element 41 on the basis of the thickness of the substrate or the intermediate layer of the optical disc D detected by the thickness difference detection circuit 6, etc.

The actuator driving circuit 4 is used to move the position of an unshown actuator holding the objective lens 31 in the PUH 11 in the focus (optical axis) direction perpendicular to a surface of the optical disc D including the recording layer (to control focus) so that the distance between the objective lens 31 and the recording layer of the optical disc D coincides with the focal distance of the objective lens 31, and to move the objective lens 31 in the radial direction (of the optical disc D) perpendicular to the direction in which the track (recording mark row) of the recording layer extends (to control tracking).

The laser driving circuit 5 superposes a recording signal corresponding to the information to be recorded on a laser drive signal in the case of recording information on the optical disc D, or sets predetermined light intensities of the first and second LDs 21, 23 in the case of reproducing information from the optical disc D. The laser driving circuit 5 also uses an output signal from an unshown monitor optical system to stabilize the outputs of the first and second LDs 21, 23.

The thickness difference detection circuit 6 extracts a zero crossing point of an output signal, that is to say, an S-shaped curve output from the PD 53, and a distance K between two predetermined points in the vicinity of the zero crossing point emerging before and after the zero crossing point when the objective lens 31.

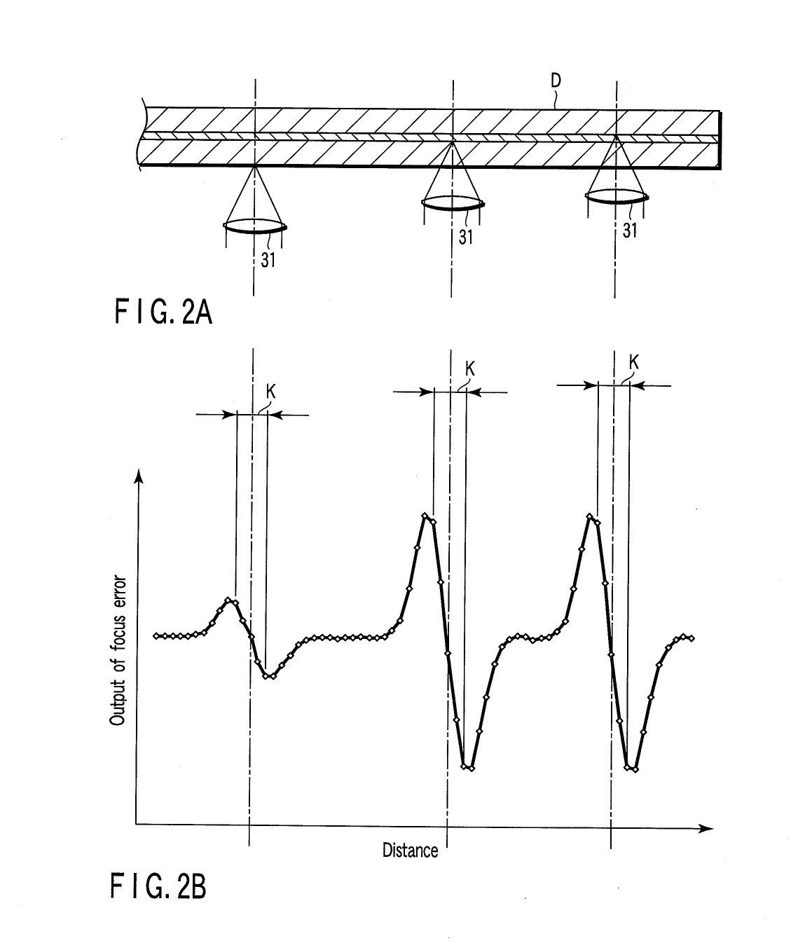

The actuator (lens holder) 13 is gradually moved in a direction which is perpendicular to the recording surface of the optical disc D and in which the objective lens 31 approaches the recording surface of the optical disc D as described below using FIG. 2 after moved to a predetermined position distant from the recording surface for focus detection. Then, the thickness difference detection circuit 6 detects the thickness of the transparent substrate or the intermediate layer from the distance between each point and the zero crossing point.

Specifically, as shown in FIG. 2A, a focus error signal generally shows the S-shaped curve in which polarity is inverted before and after a zero crossing, in the order of the surface of the transparent substrate of the optical disc D, the first recording layer and the second recording layer, as a drive signal supplied to the focus coil 15 of the actuator (lens holder) 13 is substantially linearly increased as shown in FIG. 2B.

At this point, in a given S-shaped curve, the distance between an initial peak output (the light reflected by the surface of the disk) and the following output (after inversion, the light reflected by the surface of the first recording layer or the second recording layer), that is to say, each of the value of K depends on the NA of the objective lens 31 and the shape error of the lens holder which is a part of the actuator 13, that is to say, the positional relation of individual elements installed in the actuator 13, or depends on, for example, output characteristics of the PD 53, and varies from PUH to PUH.

Therefore, for each PUH (optical head device), the value of K is measured which is “the distance between the initial peak output or the output of its neighboring predetermined position, and the following peak (bottom) output (after inversion) or the output of its neighboring predetermined position” of a detection characteristic inherent in the focus error signal, that is to say, the S-shaped curve in which polarity is inverted before and after the zero crossing.

The measured value is stored in, for example, unshown nonvolatile memory, such that an output value output in accordance with the distance between points across the zero crossing point included in the focus error signal can then be used as the thickness of the transparent substrate of the optical disc or the intermediate layer.

The thickness of the transparent substrate or the thickness of the intermediate layer thus obtained is measured at a plurality of positions in one optical disc, for example, at radially different positions or at a plurality of positions with different rotation angles in the same radius, such that it is possible to find the distribution or variation of third-order spherical aberration (SA3) caused by the difference of the thickness of the disc substrate.

In addition, the found distribution or variation of the SA3 is retained in the buffer 3, and can be used as the amount of control of the refractive index converting element 41 by the spherical aberration correction circuit 7 described below.

Furthermore, when the optical disc D is a writable disc, the found control amount can be written in, for example, a BCA area and used to reduce the influence of the SA3 in a short time, for example, in the case where the optical disc D is once removed from the optical disc device and again set in the optical disc device. In other words, when the optical disc D used for reproduction or recording in the past in the same optical disc device is again set, it is possible to reduce rising time before the recording and reproduction of information is enabled.

The spherical aberration correction circuit 7 supplies, across electrodes of the refractive index converting element 41 which are not described in detail, a control voltage set on the basis of the variation and distribution of “the distance between the transparent substrate of the optical disc D and the first recording layer, that is to say, the thickness of the transparent substrate” or “the distance between the first recording layer and the second recording layer, that is to say, the thickness of the intermediate layer”.

Thus, the objective lens 31 is focused on each recording layer within a predetermined margin of error even if the optical disc D has two or more recording layers. Therefore, in the case of defocus caused by the focus error, the operation of the actuator as if a focus error were detected due to the thickness difference of the transparent substrate or the intermediate layer of the optical disc is reduced, such that the objective lens 31 (actuator) is stably controlled. Moreover, as the focus control is stabilized, it is possible to expect a reduction in the frequency of, for example, deviation from the track (tracking error).

Next, one example of the operation in the optical disc device 101 shown in FIG. 1 will be described.

When an optical disc held on a turntable formed integrally with an unshown disc motor is of, for example, the HD DVD standard, a light beam at a wavelength of 405 nm is output from the first LD 21.

The light beam at a wavelength of 405 nm penetrates the PBS 33, is collimated by the collimator 35, passes the second splitter 37, the λ/4 plate 39 and the refractive index converting element 41, and is converged on the recording layer of the optical disc D by the objective lens 31 at a predetermined spot size.

A reflection light beam reflected by the recording layer of the optical disc D is captured by the objective lens 31, returned to parallel light, passes the refractive index converting element 41 and the λ/4 plate 39, and is reflected by the second splitter 37 toward the PD 53.

The reflection light beam directed to the PD 53 is given the predetermined imaging property by the imaging optical system 51. In addition, any known optical system for detecting the focus error of the objective lens 31 and the tracking error can be used as the imaging optical system 51. As a method of detecting the focus error, a knife edge method, a double prism (parallel prism) method or an astigmatic method is used, for example. As a method of detecting the tracking error (deviation from the track), a combination of a differential phase detection (DPD) method and a push-pull (PP) or compensated push-pull (CPP) method is applied, for example.

In addition, the refractive index converting element 41 is provided at a predetermined position between the objective lens 31 and the PBS 33, and the distribution (variation) of the difference of the thickness of the transparent substrate of the optical disc D and the intermediate layer between the recording layers is detected by the thickness difference detection circuit 6, and the spherical aberration correction circuit 7 is used to suitably control the refractive index of the refractive index converting element 41 in accordance with the difference of thickness, such that even when the optical disc D has two or more recording layers, each recording layer is focused on within a predetermined margin of error.

Therefore, in the case of defocus caused by the focus error, the operation of the actuator as if a focus error were detected due to the thickness difference of the transparent substrate of the optical disc or the intermediate layer is reduced, such that the objective lens 31 (actuator) is stably controlled.

Moreover, as the focus control is stabilized, it is possible to expect a reduction in the frequency of deviation from the track (tracking error).

Likewise, when an optical disc held on the turntable formed integrally with the unshown disc motor is of, for example, the DVD standard, a light beam at a wavelength of 655 nm is output from the second LD 23.

The light beam at a wavelength of 655 nm is reflected by the PBS 33, collimated by the collimator 35, passes the second splitter 37, the λ/4 plate 39 and the refractive index converting element 41, and is converged on the recording layer of the optical disc D by the objective lens 31 at a predetermined spot size.

A reflection light beam reflected by the recording layer of the optical disc D is captured by the objective lens 31, returned to parallel light, passes the refractive index converting element 41 and the λ/4 plate 39, is reflected by the second splitter 37 toward the PD 53, given the predetermined imaging property by the imaging optical system 51, and imaged on the PD 53.

At this point, the refractive index of the refractive index converting element 41 is suitably set by the spherical aberration correction circuit 7 in accordance with the distribution (variation) of the difference of the thickness of the transparent substrate of the optical disc D and the intermediate layer between the recording layers.

Thus, even when the optical disc D has two or more recording layers, each recording layer is focused on within a predetermined margin of error. Therefore, in the case of defocus caused by the focus error, the operation of the actuator as if a focus error were detected due to the thickness difference of the transparent substrate of the optical disc or the intermediate layer is reduced, such that the objective lens 31 (actuator) is stably controlled.

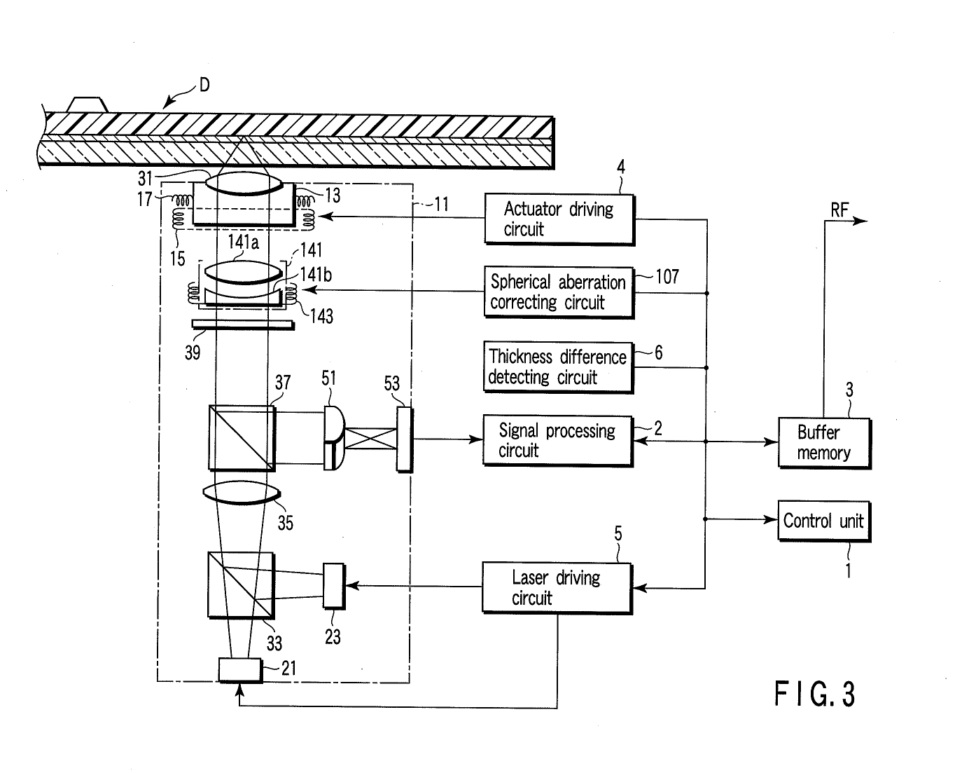

In addition, a relay lens 141 can be used instead of the refractive index converting element 7 shown in FIG. 1, as shown in FIG. 3. In this case, the relay lens 141 uses a combination of a convex lens 141a and a concave lens 141b, and one of these lenses can only be moved to prevent the change of the amount of light. Moreover, it goes without saying that a relay lens coil 143 for moving one of the lenses of the relay lens 141 in the optical axis direction is provided in the example shown in FIG. 3.

In this case, a spherical aberration correction circuit 107 outputs a current/voltage for moving the relay lens coil 143 a predetermined distance.

As described above, in the optical head device (and the optical disc device) of this invention, the distance between the transparent substrate of the optical disc and the first recording layer, that is to say, the thickness of the transparent substrate or the distance between the first recording layer and the second recording layer, that is to say, the thickness of the intermediate layer, and the accumulation of thickness differences are detected from signals obtained as focus error signals at a plurality of positions of the optical disc on the basis of a predetermined lens moving distance across the zero crossing point when the objective lens is moved in the focus direction perpendicular to the recording surface of the optical disc.

For each position where the detection has been carried out, the convergence property (imaging property) of the light beam converged on the recording layer by the objective lens is compensated for by the spherical aberration correction circuit.

In other words, the thickness of the intermediate layer in the optical disc in which two or more recording layers are formed is detected at a plurality of positions of the optical disc, and the convergence property (imaging property) of the light beam converged on the recording layer by the objective lens is compensated for by the spherical aberration correction circuit for each position where the detection has been carried out.

In the case of defocus caused by the focus error, the operation of the actuator as if a focus error were detected due to the thickness difference of the transparent substrate of the optical disc or the intermediate layer is reduced, such that the objective lens 31 (actuator) is stably controlled. As a result, the focus control is stabilized, such that it is possible to expect a reduction in the frequency of, for example, deviation from the track (tracking error).

Therefore, information can be stably recorded in each of the arbitrary number of recording layers provided on the transparent substrate. Moreover, reproduction errors are reduced in the reproduction of information as well.

Furthermore, in a recordable optical disc, the difference of the thickness of the transparent substrate or the intermediate layer that has been found is recorded in a predetermined region, such that rising time required before the recording and reproduction of information is enabled can be reduced when the optical disc used for reproduction or recording in the past is again set.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical pickup head device comprising:
a light source configured to output light;
an objective lens configured to cause the light from the light source to converge on a recording layer of a recording medium, and to capture reflection light reflected by the recording layer;
a photodetector configured to receive the reflection light captured by the objective lens and to output an output signal corresponding to the intensity of the reflection light;
a signal processing circuit configured to set, based on the output of the photodetector, a control value to move the objective lens so that the distance between the objective lens and the recording layer coincides with the focal length of the objective lens;
an optical path length correction mechanism which is located between the light source and the objective lens and which is configured to correct the influence of an aberration component that produces an error in the focal length of the objective lens on the basis of the distance between a transparent substrate of the recording medium and the recording layer of the recording medium;
a thickness difference detection circuit configured to determine an amount of correction to be made by the optical path length correction mechanism based on the output of the photodetector; and
an aberration correction circuit configured to generate a correction signal to correct the influence of the aberration component, and to supply the correction signal to the optical path length correction mechanism.

2. The optical pickup head device according to claim 1, wherein
the thickness difference detection circuit is configured to determine the distance between the transparent substrate and the recording layer of the recording medium based on a focus error signal obtained by the photodetector when the objective lens is gradually moved toward the recording layer, the determination being further based on a zero crossing point where the polarity of the focus error signal is inverted and on values at two predetermined points in the vicinity of the zero crossing point before and after the zero crossing point.

3. The optical head device according to claim 2, wherein
the thickness difference detection circuit is configured to extract a zero crossing point in an S-shaped curve of the output signal from the photodetector, as well as the two predetermined points before and after the zero crossing point, and to detect the thickness of the transparent substrate on the basis of an initial zero crossing point and a subsequent zero crossing point.

4. The optical pickup head device according to claim 1, wherein
the optical path length correction mechanism comprises a liquid crystal element in which a liquid crystal layer is interposed between electrodes and whose refractive index changes in response to a voltage applied across the electrodes.

5. The optical pickup head device according to claim 1, wherein
the optical path length correction mechanism comprises a first lens provided with a first polarity and a second lens provided with a polarity that is the reverse of the first polarity, and wherein one of the first and second lenses comprises a relay lens mechanism configured to be moved in the direction of the optical axis of the objective lens.

6. An optical disc device comprising:
a light source configured to output light;
an objective lens configured to cause the light from the light source to converge on a recording layer of a recording medium, and to capture reflection light reflected by the recording layer;
a photodetector configured to receive the reflection light captured by the objective lens and to output an output signal corresponding to the intensity of the reflection light;
a signal processing circuit configured to set, based on the output of the photodetector, a control value to move the objective lens so that the distance between the objective lens and the recording layer coincides with the focal distance of the objective lens;
an optical path length correction mechanism which is located between the light source and the objective lens and which is configured to correct the influence of an aberration component that produces an error in the focal distance of the objective lens on the basis of the distance between a transparent substrate of the recording medium and the recording layer of the recording medium;
a thickness difference detection circuit configured to determine an amount of correction to be made by the optical path length correction mechanism based on the output of the photodetector;
an aberration correction circuit configured to generate a correction signal to correct the influence of the aberration component, and to supply the correction signal to the optical path length correction mechanism;
an actuator configured to hold at least the objective lens and to move the objective lens so that the distance between the objective lens and the recording layer of the recording medium coincides with the focal distance of the objective lens;
a driver configured to generate power to move the actuator; and
a rotator configured to rotate the recording medium at a predetermined velocity.

7. The optical disc device according to claim 6, wherein
the thickness difference detection circuit is configured to determine the distance between the transparent substrate and the recording layer of the recording medium based on a focus error signal obtained by the photodetector when the objective lens is gradually moved toward the recording layer, of the determination being further based on a zero crossing point where the polarity of the focus error signal is inverted and on values of two predetermined points in the vicinity of the zero crossing point before and after the zero crossing point.

8. The optical disc device according to claim 7, wherein
the thickness difference detection circuit is configured to extracts a zero crossing point in an S-shaped curve of the output signal from the photodetector, as well as the two predetermined points before and after the zero crossing point, and to detect the thickness of the transparent substrate on the basis of an initial output zero crossing point and a subsequent output zero crossing point.

9. A method of using an optical disc device, comprising:
moving an actuator that holds a lens which converges light from a light source on a recording layer of a recording medium to a predetermined position distant from the recording layer of the recording medium, and then gradually moving the actuator toward the recording layer of the recording medium;
finding, based on a reference movement amount which inverts the polarity of an output of a photodetector, a first output obtained a predetermined amount before the reference movement amount and a second output obtained a predetermined amount after the reference movement amount with regard to each of the surface of a transparent substrate of the recording medium and the recording layer thereof;
finding the thickness of the transparent substrate at a plurality of angular and radial positions in a recording surface of the recording medium based on the positions of the surfaces of the transparent substrate and the recording layer; and
correcting a focal distance inherent in the lens based on the thickness of the transparent substrate found at the plurality of angular and radial positions in the recording surface of the recording medium.
